(19) United States
(12) Patent Application Publication
(10) Pub. No.: US 2003/0097937 A1
(43) Pub. Date: May 29, 2003

(54) Fermentation apparatus for automated wine making

(75) Inventor: Marco Francia, Casale Monferrato (IT)

Correspondence Address: SUGHURE MION, PLLC, 2100 Pennsylvania Avenue, NW, Washington, DC, 20037-3213, US

(73) Assignee: GIMAR TECNO S.R.L.

(21) Appl. No.: 10/267,794

(22) Filed: Oct. 10, 2002

(30) Foreign Application Priority Data
Oct. 11, 2001 (IT) TO2001A000965

(51) Int. Cl. A23L 1/00

(52) U.S. Cl. 99/275

(57) ABSTRACT

Automatically operating fermentation equipment: for winemaking of the type comprising:

a main vat designed to contain the two-phase liquid/solid winemaking substrate,

an upper vessel located above the main vat provided with valve means for discharging liquid from the upper vessel into the main vat,

a riser pipe which feeds the liquid undergoing fermentation from the bottom portion of the main vat to the upper vessel or selectively to the main vat, provided with two separate devices for controlled oxygenation of the fermenting liquid,

heat exchange means for controlling the temperature of the substrate,

actuator means designed to effect and control the circulation of liquid within the fermentation equipment and designed to activate the said heat exchange means,

sensor means to detect chemical and physical parameters of the substrate correlated with the stages in the fermentation process, and

a control and monitoring unit associated with the said sensor and actuator means designed to control the winemaking cycle.

The said control and monitoring unit comprises a display screen, control means which can be operated by an operator and processing means designed to display at least one graphic representation of the equipment, together with the location of the sensor and/or actuator means associated with the equipment, and the value of a number of parameters for the winemaking process detected by the said sensors or derived from parameters detected by the said sensors and the activation/deactivation status of the actuator means on the said screen.

### DESCRIPTION

This invention relates to automatically operating fermentation equipment for winemaking provided with a control and monitoring unit for control of the winemaking cycle.

In particular the invention relates to equipment of the type comprising:

a main vat intended to contain the two-phase liquid/solid substrate used in winemaking,

an upper vessel located above the main vat provided with valve means for discharging liquid from the upper vessel into the main vat,

a riser pipe which feeds the liquid undergoing fermentation from the bottom portion of the main vat to the upper vessel or selectively to the main vat, (preferably provided with two separate devices for controlled oxygenation of the fermenting liquid, as better described below),

heat exchange means for controlling the temperature of the substrate,

actuator means designed to effect and control the circulation of liquid within the fermentation equipment and designed to activate the said heat exchange means,

sensor means to detect chemical and physical parameters in the substrate correlating with the stages of the process carried out in the equipment, and

a control and monitoring unit associated with the said sensor and actuator means designed to manage the winemaking cycle.

Fermentation equipment of the abovementioned type is described in Italian patents no. 1,289,672 and no. 1,293,978, patent applications TO99U000204 and TO2000A000235 and U.S. Pat. No. 6,279,457.

The scope of the invention is to provide equipment which also enables an unspecialised operator to easily control the various stages in the process carried out by the winemaking equipment which enables the operator to easily select the desired stages in the process and act promptly in the event of malfunctions or alarm situations.

With this object the subject matter of the invention comprises equipment of the abovementioned type characterized in that the said control and monitoring unit comprises a display screen, control means which can be operated by an operator and processing means designed to display at least a graphical representation of the equipment together with the location of sensor and/or actuator means associated with the equipment and the value of a number of recorded parameters or parameters derived from recorded parameters on the said screen.

Other advantages and characteristics of the present invention will become clear from the following detailed description which is given with reference to the appended drawings in which:

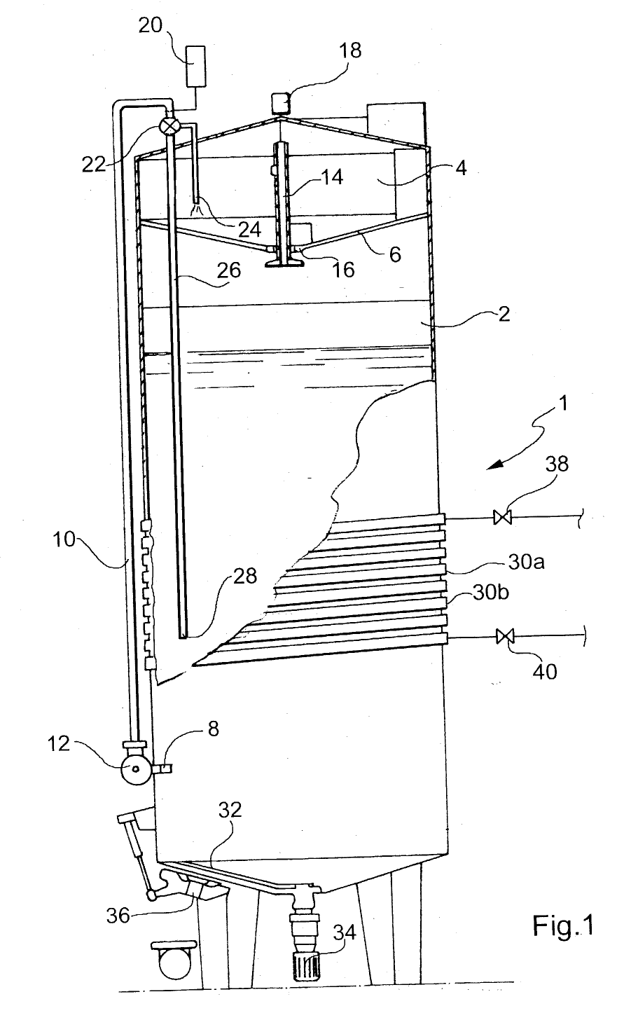

FIG. 1 is a front view in partial cross-section of fermenting equipment for winemaking according to the invention, and

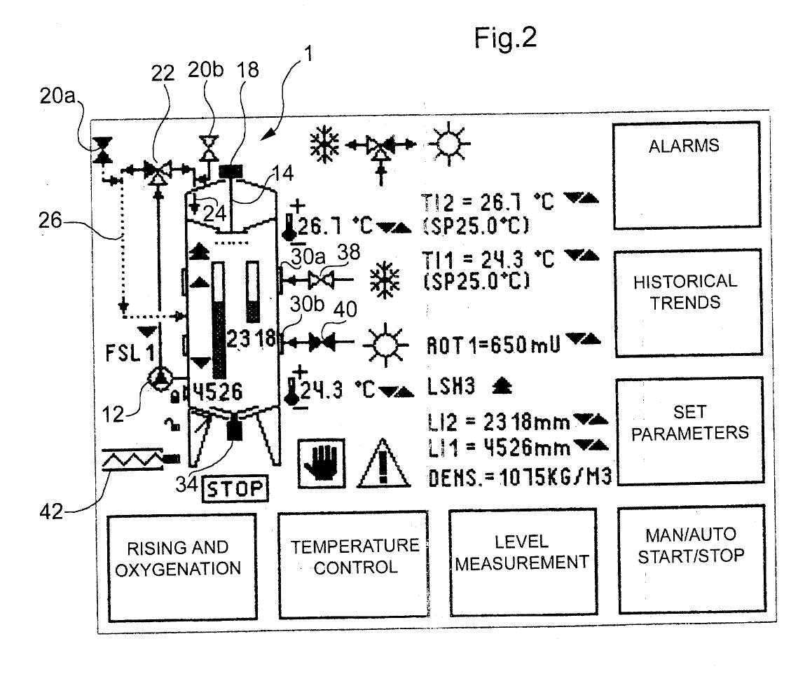

FIG. 2 is a diagrammatical representation of a graphic page displayed by the processing means on the display screen representing one stage in the process.

With reference to the drawings, 1 indicates as a whole a fermentation vat of the automatically operating type comprising a main vat 2 designed to contain the crushed harvested material and an upper vessel 4 located above main vat 2 and having a base 6 with which is associated a plug 14 engaging a central opening 16 in the base; plug 14 is operated by a pneumatic or electrically controlled piston 18.

Riser means comprising a suction pipe 8 which communicates with the lower portion of vat 2 and a delivery pipe 10 which feeds liquid to upper vessel 4, between which is located a pump 12, is associated with the fermentation vat.

In accordance with an optional and preferred embodiment described in Italian patent no. 1,293,978 and application TO2000A000235, oxygenation means comprising an injector 20 designed to inject a flow of ambient air suitable for performing effective oxygenation into the liquid flowing through the riser pipe are associated with delivery pipe 10.

Downstream from injector 20, a valve 22 communicating with a pipe 24 which delivers liquid to upper vessel 4 and a pipe 26 which delivers liquid into the mass of fermenting liquid through a drainage opening 28 is located in delivery pipe 10. Valve 22 may be a manual valve or preferably a servo-assisted automatic valve, in which case it may be controlled by the control and monitoring unit described below. Valve 22 is typically a three-way valve, designed to feed liquid selectively to vessel 4 through pipe 24 or to vat 2 through pipe 26 or to shut off the feed of liquid through the riser pipe.

Heat exchange means 30a, 30b, comprising for example one or more coils surrounding the body of the vat and/or a coil associated with the base of main vat 2, as described in application TO99U000204, are also associated with the fermentation vat; the heat exchange coil or coils are fed with cooling and/or heating fluids through valve means 38, 40 which may be servo-controlled. A rotating scraper member 32 driven by an electric motor 34 to discharge marc, a discharge hatch 36, which may be motor-driven, and optionally a screw extractor member 42 (FIG. 2) for discharge of the marc are further associated with the fermentation vat.

The fermentation vat also comprises sensor means, including temperature sensors, to determine the temperature of the fermenting liquid and pressure sensors, which will be described more fully below, as well as optionally sensor means to measure the dissolved oxygen concentration, present in combination with or as an alternative to devices for the measurement of redox potential.

Washing means suitable for washing the internal walls of the fermentation vat with various wash liquids and/or flows of liquid which can be selected by the operator may also be envisaged.

The fermentation equipment further comprises a control and monitoring unit which is associated with the sensor means and the actuator means and is designed to control the stages of the process performed in the equipment.

Provision may also be made, on an optional basis, for the remote control of some functions of the equipment by PC with a specific control program, performed through a serial connection to the control and monitoring unit.

The control and monitoring unit comprises a display screen and processing means designed to display a graphical representation of the equipment, together with the location of the sensor means and/or actuator means associated with the equipment on the screen; in addition to this the processing means are designed to display the value of process variables which are measured or calculated on the basis of parameters measured by the sensor means.

As an interface with the operator the control and monitoring unit also comprises control means which allow the operator to enter commands and settings, comprising for example a keyboard with a plurality of keys. It is intended that equivalent control means, for example control means incorporated into the display screen, such as a touch-screen, may be envisaged.

The processing means are also designed to display a plurality of graphic pages, each representing a stage in the process performed by the equipment, and to associate a specific function correlated to the currently displayed graphic page with the control means; at least one graphic page, for example that illustrated in FIG. 2, comprises a diagrammatical illustration of fermentation equipment 1 and the actuator means associated with it. It is intended that the actuator means associated with the fermentation equipment and displayed on the screen by the control and monitoring unit may be selected from one or more of the previously described actuator means and in particular from among:

riser pump 12,

servo-controlled 3-way valve means 22,

electrically controlled piston 18 for the operation of plug 14,

oxygen injection means 20a or 20b, for injecting oxygen into pipe 26 or 24 respectively,

motor 34 for driving scraper blade member 32,

screw 42,

valve means 38 for delivering cooling fluid to heat exchange means 30a, and

valve means 40 for delivering heating fluid to heat exchange means 30b,

actuator means for operating the washing means.

The processing means may be arranged so that they indicate the actuator means which are in operation in the current process stage on the graphic representation of the equipment and the actuator means.

The graphic page also displays measured or calculated chemical and physical parameters comprising one or more from among: the temperature values measured in one or more predetermined zones of the substrate undergoing fermentation (identified by TI1 and TI2), the value of the redox potential ROT1, the value of the dissolved oxygen concentration (DOL1), the density of the fermenting liquid (dens), and possibly level measurement with respect to a predetermined position LT1 and LT2; these level measurements are preferably calculated on the basis of values of pressure in the liquid measured by pressure sensors.

Along its perimetral edges the graphic page may also comprise a plurality of boxes to each of which is allocated a specific function, each of the said boxes being combined with a control button which when operated by the operator causes display of a graphic page corresponding to the function illustrated in the corresponding box, or giving rise to the activation of a command.

It is intended that an equivalent function may be performed by using squares having a touch-screen function.

The control and monitoring unit is designed to manage the process in three main operating stages and possibly one or more auxiliary stages, for example a wash stage, each of which correspond to one different graphic page and in particular:

a storage stage,

a winemaking stage,

an extraction stage.

In each of the abovementioned stages only the functions and/or actuator means envisaged by the current operating stage are activated—and if appropriate displayed as being active.

In particular, temperature control, level measurement and density measurement and calculation, to which more detailed reference will be made below, are enabled during the storage stage.

All the functions inherent in management and control of the must fermentation process are activated during the winemaking stage; in particular the functions of temperature control, level measurement, measurement/calculation of density and the actuator means designed to cause liquid to rise from the main vat to the upper vessel or, selectively, from the lower portion of the main vat to an intermediate portion in that vat, and discharged as rain or a jet of liquid contained in the upper vessel into the main vat with, if appropriate, oxygenation of the liquid in the riser pipe.

With regard to the temperature control function, which may be activated for example during the storage and/or winemaking stages, the control and monitoring unit is preferably designed to permit the operator to set a gradient for change in temperature between the current value and the desired final value over times which can be preset or selected by the operator, varying the value of the temperature required (set point) over time in accordance with a curve which is predetermined or which can be defined by the operator.

The possibility of choosing the times and time curve for the change in temperature is of particular importance for avoiding thermal shocks during the fermentation stage.

In the course of the extraction stage the functions inherent in operation of the wine and marc discharging devices, and in particular control of marc extractor 32, 34, winemaking hatch 36, screw 42 and determination of the liquid level, are activated.

In a preferred embodiment, measurement and control of the level of liquid in the fermentation vat is effected through the use of at least a first pressure sensor immersed in the winemaking substrate at a predetermined level within the main vat so as to provide the control and monitoring unit with a signal which represents the pressure exerted on the sensor by the hydraulic head. The processing means of the control and monitoring unit are designed to calculate the parameter for the level of liquid in the main vat on the basis of a predetermined reference value for the density of the liquid selected on the basis of the stage in the fermentation cycle in progress.

In particular, the level may be calculated using the equation

H=p₁/(d·9.81)+h₁,

where

H is the level of liquid within the winemaker,

d is the reference density of the liquid, kg/m³,

p₁ is the pressure measured by the sensor, N/m²,

h₁ is the level at which the pressure sensor is installed.

The control and monitoring unit is designed to display the value of the level determined on the screen and if necessary to activate an alarm function when the value for the level is greater than or less than a predetermined threshold.

Furthermore, the processing means of the control and monitoring unit are preferably designed to calculate (and optionally display on the screen) the value of the level of liquid in the upper vessel on the basis of the value of the level determined for the main vat, the geometrical data for the winemaker and the volume loaded.

Thus, even using a single sensor associated with the main vat it is possible to obtain the value for the level in the upper vat, enabling the operator to adjust the value in order to obtain different effects on the cascade of liquid from the upper vessel into the main vat.

The manometric level sensor described above is also useful for controlling the progress of winemaking. It is in fact known that changes in level and density associated with the conversion of sugars and the release of gaseous substances (CO₂) which are released from the liquid mass take place within the fermenting mass during winemaking. The pressure measurement performed by the manometric level sensor therefore provides useful indirect indications about changes in density and therefore the progress of the fermentation process.

In accordance with a preferred option the abovementioned pressure sensor may be associated with a second pressure sensor immersed to a different predetermined level within the winemaking substrate. In this case, with two sensors, the pressure measurements may be used by the control and monitoring unit to calculate the density of the liquid present in the winemaker (which changes with the progress of fermentation) in accordance with the relationship

d=(p₁−p₂)/(9.81·(h₂−h₂),

where

p₁ and p₂ are the pressures measured by the sensor, N/m²,

h₁, h₂ are the levels at which the first and second sensor are installed, m.

The level within the winemaker may also be calculated on the basis of the pressure measurements provided by the two sensors by also using the predetermined reference density value. The two level measurements so obtained are compared and if the relative difference between the two measurements is less than a permitted value (approximately <5%) the measurements are considered to be valid and the system may proceed to calculate the density, the value of which is displayed and used instead of the reference density to calculate the level and volume or mass present in the winemaker.

Measurement of level on the basis of pressure values enables the operator to act in the event of abnormal or alarm situations which can for example arise when the layer of marc floating on the fermenting must acts as a cap following compaction of the marc and prevents fermentation gas from being released through the cap. In such circumstances a situation occurs in which the volume beneath the cap increases and the cap rises, even to the point where it blocks plug 14, with a further increase in pressure.

The level control system based on pressure measurements as described above enables the operator to immediately display abnormal operating situations of the type described above and to act to restore proper operation, for example by automatically activating a rising flow, thus disaggregating the cap by spraying the cap with a jet from the upper vessel.

The control and monitoring unit may also be designed to control the process during the winemaking stage on the basis of the value of the calculated density, the change in which in the course of the process may also be displayed on the screen (e.g. in the form of a graph) to permit the operator to understand the progress of the fermentation process. In particular the control and monitoring unit provides the operator with an opportunity to operate the equipment in preprogrammed cycles of rising, oxygenation and/or spraying of the cap on the basis of the calculated density.

The control and monitoring unit also makes it possible to control the winemaking process on the basis of different values which are assigned to the “key” parameters for the process. These values may be placed in memory and subsequently recalled on the basis of “recipes” or “operating instructions” which are predetermined and which can be personalised by the operator.

The control and monitoring unit also indicates and records alarm conditions or abnormal conditions. Every alarm is indicated by activating an acoustic signalling device and/or an indicator lamp with a flashing light. The operator can acknowledge the alarm with consequent cancellation of the acoustic signal, and if the condition which gave rise to the alarm remains active the indicator lamp shows a steady light instead of flashing. When all the abnormal conditions have been removed or cancelled, the steady light indicator lamp is also deactivated.

Another optional function of the control and monitoring unit consists of placing process parameters in memory during the course of the fermentation cycle.

In accordance with another function the control and monitoring unit may be designed to control the operation of one or more units outside the winemaker, such as for example a water cleaning device for washing the winemaker; for this purpose a graphic page representing the control and operating parameters and/or the actuators of the external unit may be displayed.

Naturally, the principle of the invention remaining the same, the forms of embodiment and details of construction may be varied widely with respect to those described and illustrated without thereby departing from the scope of the following claims.

What is claimed is:

1. Automatically operating fermentation equipment for winemaking of the type comprising:
a main vat designed to contain the two-phase liquid/solid winemaking substrate,
an upper vessel located above the main vat provided with valve means for discharging liquid from the upper vessel into the main vat,
a riser pipe which feeds the liquid undergoing fermentation from the lower portion of the main vat to the upper vessel or selectively to the main vat,
heat exchange means for controlling the temperature of the substrate,
actuator means designed to effect and control the circulation of liquid within the fermentation equipment and designed to activate the said heat exchange means,
sensor means to detect chemical and physical parameters of the substrate correlated with the stages in the fermentation process, and
a control and monitoring unit associated with the said sensor and actuator means designed to control the winemaking cycle,
wherein the said control and monitoring unit comprises a display screen, control means which can be operated by an operator and processing means designed to display at least one graphic representation of the equipment together with the location of the sensor and/or actuator means associated with the equipment, together with the value of a number of parameters for the winemaking process detected by the said sensors or derived from parameters detected by the said sensors and the activation/deactivation status of the actuator means on the said screen.

2. Fermentation equipment according to claim 1, wherein the said processing means are designed to:
display a plurality of graphic pages, each representing one stage in the winemaking process, and
associating to each of said control means a function correlating with the graphic page currently displayed.

3. Fermentation equipment according to claim 1, wherein the said processing means are designed to enable/disable actuator means which are or respectively are not designed to perform the process operations inherent respectively in the current process stage on the basis of the process stage displayed.

4. Fermentation equipment according to claim 1, wherein the parameters displayed on the said display screen comprise one or more of the following parameters:
temperature of the substrate,
level of substrate within the winemaker,
density of the liquid,
dissolved oxygen concentration,
redox potential,
time from the start of winemaking.

5. Fermentation equipment according to claim 1, wherein the said actuator means which can be displayed and/or activated by the control and monitoring unit comprise one or more of the following actuator means:
actuator means for performing cycles of rising flow from the lower portion of the main vat to the upper vessel,
actuator means for discharging liquid from the upper vessel into the main vat,
actuator means for storage and discharge,
actuator means for thermal control,
actuator means for washing the main vat and/or upper vessel.

6. Fermentation equipment according to claim 1, further comprising actuator means for injecting oxygen into the fermenting liquid, and wherein the said control and monitoring unit is capable of displaying and activating the said actuator means.

7. Fermentation equipment according to claim 1, wherein the said sensor means comprise at least a pressure sensor immersed in the winemaking substrate at a predetermined level in the main vat and in which the processing means are designed to calculate the parameter for the level of liquid in the main vat on the basis of a reference density value for the liquid which is predetermined on the basis of the current stage of the fermentation cycle.

8. Equipment according to claim 7, wherein the said processing means are designed to display the calculated value for the level of liquid on the said screen and to activate an alarm signal and/or activate actuator means to cause liquid to rise from the main vat to the upper vessel when the determined level value exceeds a predetermined threshold value.

9. Fermentation equipment according to claim 1, wherein the said sensor means comprise one or more pressure sensors immersed at predetermined levels in the winemaking substrate and in which the processing means are designed to calculate the value of the density of the liquid on the basis of the pressure value(s) found.

10. Fermentation equipment according to claim 9, wherein the processing means are designed to calculate the level of liquid and display the said level on the said display screen on the basis of the calculated density value.

11. Fermentation equipment according to claim 1, wherein the processing means are designed to display the change in the value of the density of the fermenting liquid over time, optionally in the form of a graph.

12. Fermentation equipment according to claims 8 or 9, wherein the processing means are designed to calculate and display the value of the level of liquid in the upper vessel on the basis of the value of the level of liquid in the main vat.

13. Fermentation equipment according to claim 1, wherein the control and monitoring unit is designed to permit the operator to set a gradient for temperature change between the current value and the predetermined value over times which are predetermined or which can be selected by the operator.

14. Fermentation equipment according to claim 1, wherein the said processing means are designed to control the winemaking equipment on the basis of one of a plurality of predetermined operating cycles (“recipes” or “operating instructions”) which may be selected on the basis of the value of the density of the fermenting liquid.
